(19) United States
(12) Patent Application Publication
(10) Pub. No.: US 2013/0277141 A1
(43) Pub. Date: Oct. 24, 2013

(54) APPARATUS FOR QUIETING INFANT IN A PUBLIC AREA

(71) Applicants: Sam Blankenship, Eden Prairie, MN (US); Peter Blankenship, Eden Prairie, MN (US)

(72) Inventors: Sam Blankenship, Eden Prairie, MN (US); Peter Blankenship, Eden Prairie, MN (US)

(21) Appl. No.: 13/869,329

(22) Filed: Apr. 24, 2013

Related U.S. Application Data
(60) Provisional application No. 61/637,657, filed on Apr. 24, 2012.

(51) Int. Cl. G10K 11/16

(52) U.S. Cl. CPC G10K 11/16
USPC 181/198; 181/296

(57) ABSTRACT

The invention is comprised a sound deadening or sound buffering material including but not limited to, foam, plastic, or fabric that covers at least part of the child, thereby reducing both the decibel level coming from the child and the decibel level coming to the child. This creates a quieter environment for the child while serving a dual purpose to reduce any noise coming from the child.

### CLAIM OF PRIORITY

This application claims priority to provisional application No. 61/637,657 filed on Apr. 24, 2012.

### FIELD OF INVENTION

The invention relates generally to devices and systems that reduce ambient environment noise surrounding a child or infant and reduce sounds emanating from the child or infant.

### BACKGROUND

Many parents are challenged today when traveling outside their home with their infant children in dealing with trying to protect the child from loud ambient noise. Likewise, infant children may also create loud noise due to discomfort or other reasons that create disruptive sounds to others around the parent and child. It would be advantageous to have an apparatus or device that would aid parents in buffering noise to and from their infant while in a confined space.

### SUMMARY

The invention, in one embodiment, is comprised of a sheet or blanket that is partially comprised of a sound deadening or sound buffering material including but not limited to, foam, plastic, or fabric that covers part of the child, thereby reducing both the decibel level coming from the child and the decibel level coming to the child. This creates a quieter environment for the child while serving a dual purpose to reduce any noise coming from the child.

In a related embodiment, a sound deadening material or structure, covers part of the child and it can be held in place without the use of an attachment device. In alternative embodiments, an attachment device includes, but is not limited to, a strap, elastic, clip, hook and loop (i.e., Velcro®), adhesive or any other formed shape meant to aid and support the sound deadening material.

### BRIEF DESCRIPTION OF THE DRAWINGS

FIG. 1 illustrates one embodiment of a sound buffering apparatus.

FIG. 2 is a side elevation view the sound buffering apparatus of FIG. 1.

FIG. 3 is perspective view of the sound buffering apparatus of FIG. 1 in an open position.

FIG. 4 illustrates one embodiment of a sound buffering apparatus.

FIG. 5 is a side elevation view the sound buffering apparatus of FIG. 4.

FIG. 6 is perspective view of the sound buffering apparatus of FIG. 4 in an open position.

FIG. 7 illustrates one embodiment of a sound buffering apparatus.

FIG. 8 is a side elevation view the sound buffering apparatus of FIG. 1.

FIG. 9 is perspective view of the sound buffering apparatus of FIG. 1 in an open position.

### DESCRIPTION OF THE PREFERRED EMBODIMENTS

Referring now to the drawings, wherein like reference numerals designate identical or corresponding parts throughout the several views, a sound buffering apparatus (10) is disclosed that can be interchanged among a variety of infant devices, such as a baby seat, which generally comprises a canopy (15), a sealing element (20) and a panel (30), which may optionally include a closing mechanism (25), that may provide a means of moving the infant into or out of the infant holding device.

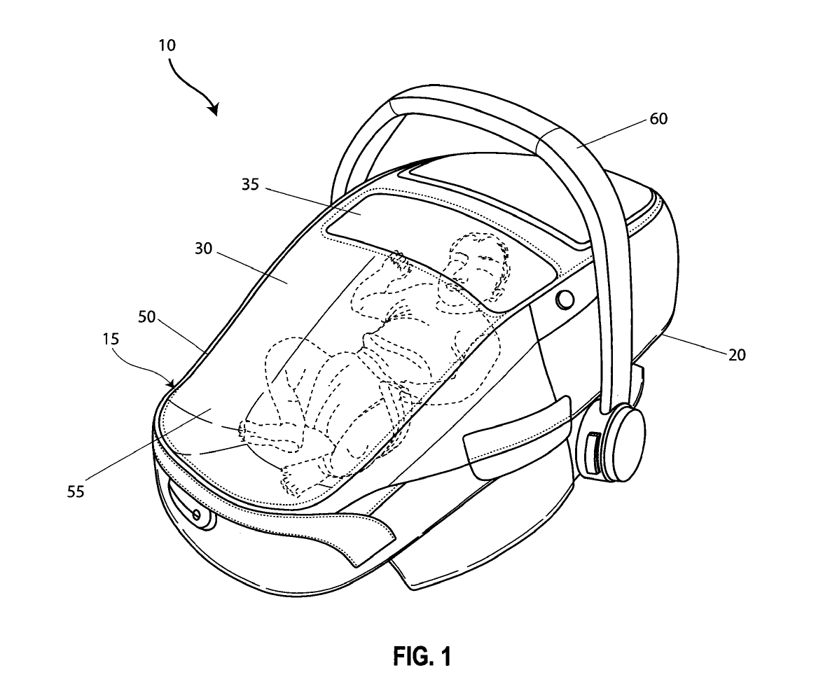

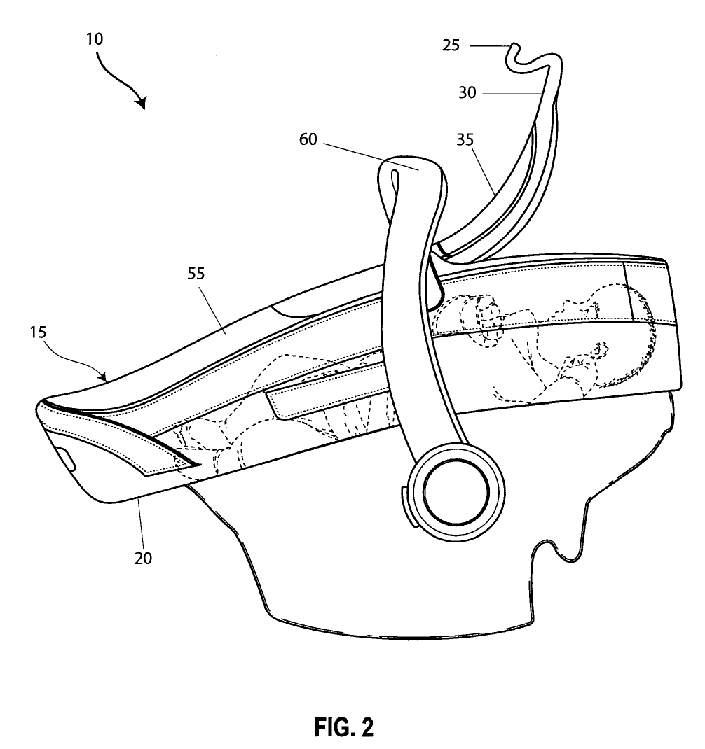

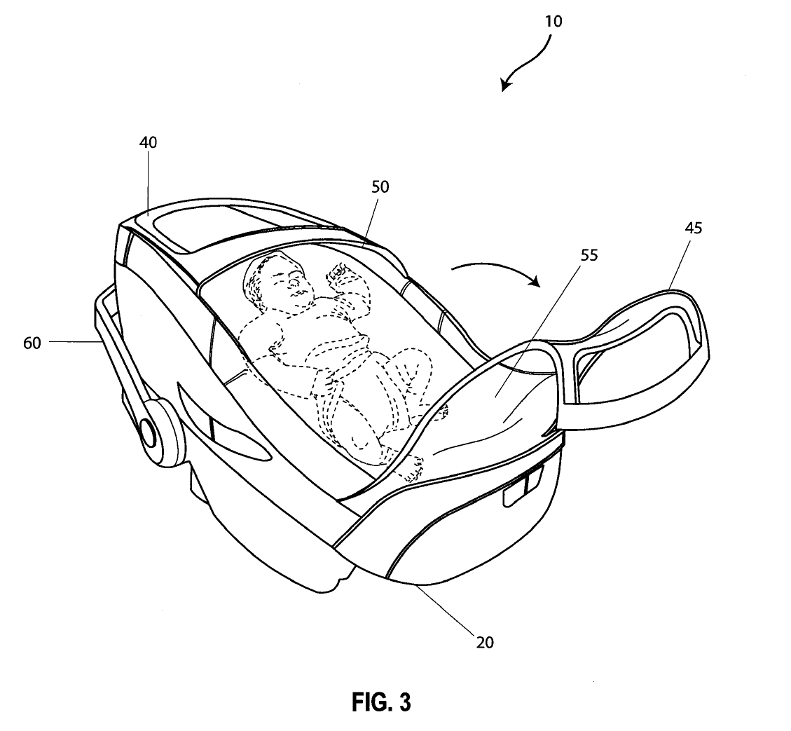

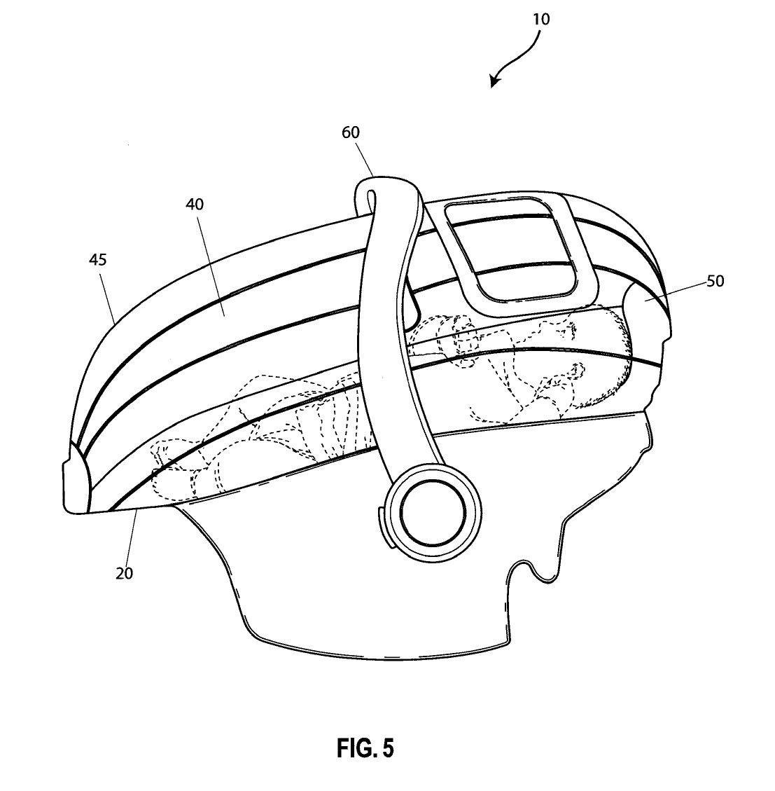

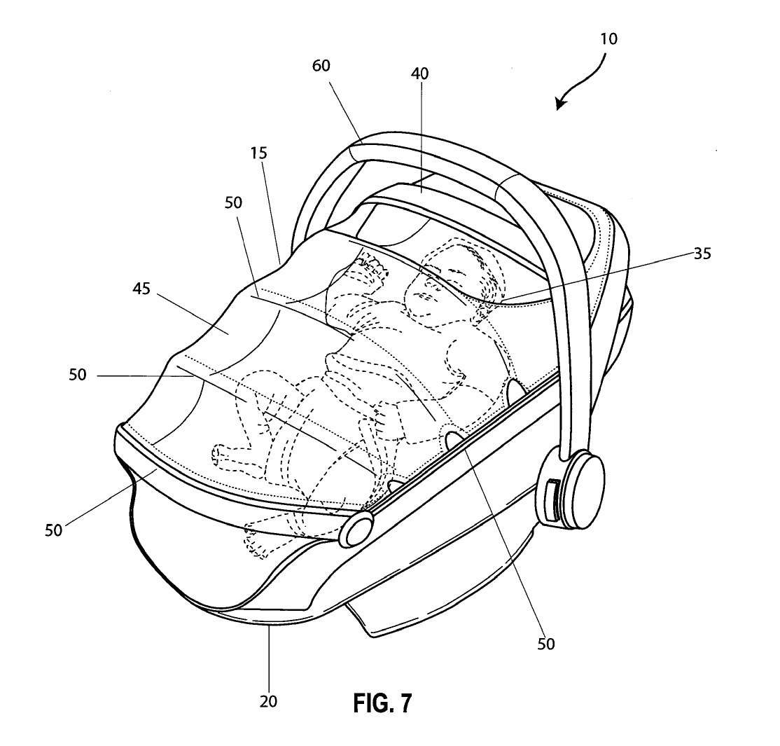

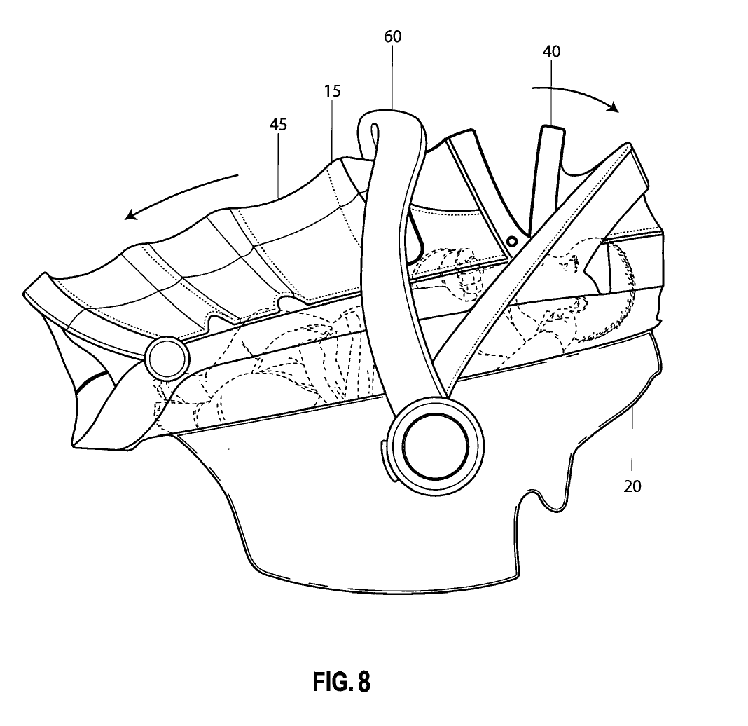

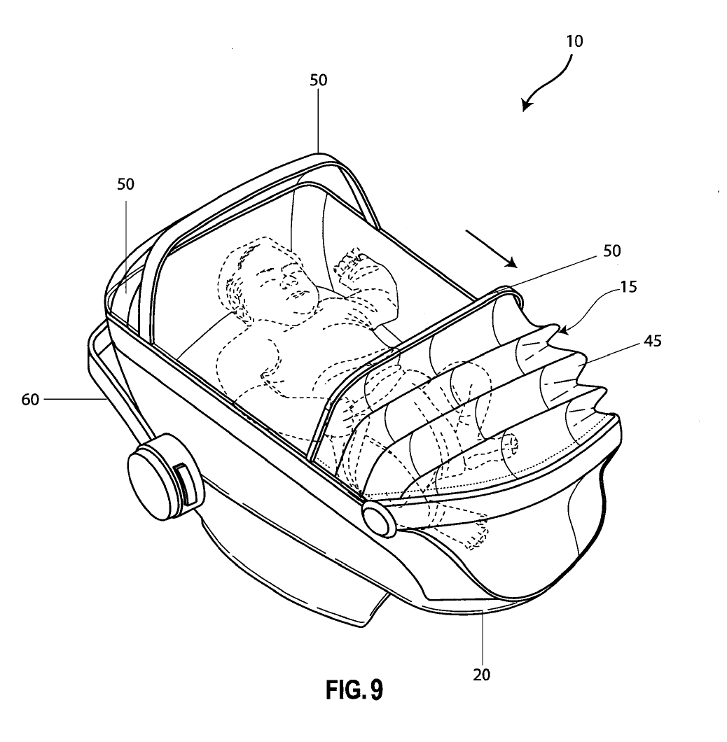

As shown in FIGS. 1-9, a sealing element (20) may be an elastic band enclosed in the canopy (15) or it may be a simple drawstring or other appropriate sealing element to seal the canopy. The first canopy section (40) and second canopy section (45) may join in the vicinity of a midpoint of the canopy (15), where support rod (50) may be used.

Panel (30) may also include a closing mechanism (25) which allows for sound buffering apparatus (10) to be closed and opened without removing sound buffering apparatus (10) from an infant device. Closing mechanism (25) may include known securement means such as fastening devices. Such devices include, but are not limited to, a strap, clip, hook and loop fastener (e.g. Velcro®), zipper, button, snap, adhesive or any other formed shapes meant to aid and support panel (30). Panel (30) may optionally include a window (35) which may be used to act as a shield from the elements or alternatively may be opened for “fresh air” or for improved viewing of the occupant under panel (30).

As shown in FIGS. 1-3, sound buffering apparatus (10), comprises a canopy (15) that may be opened and closed about an approximate midpoint of the canopy (15) to allow versatility in deploying sound buffering apparatus (10) in a rearward and/or forward direction and for fastening the canopy with closing mechanism (25). Likewise, at least a portion of canopy (15) may be folded in a forward direction with closing mechanism (25).

Canopy (15), as shown in FIGS. 1, 3-4, 6-7 and 9 provides at least two canopy sections where a support rod (50) may be located to provide structural support to canopy (15) when in use. Support rod (50) may run along the external or internal surface of canopy (15). Alternatively, support rods may also be integrally related within canopy (15). The supporting feature of rods (50) provides a means to support canopy (15) over the occupant. By the term “over,” it is intended that the canopy (15) not simply lay on the occupant in an unsupported manner.

Support rods (50) may be configured in a variety of cross-sectional shapes, such as round. This round support rod may afford an advantage in being resiliently folded to a reduced state when the cover is not in use. Alternatively, other shapes could be elliptical, rectangular, square, or other cross-sectional shapes. It may be integrated with canopy (15) and may be situated at a juncture between first enclosing canopy section (15) and second enclosing canopy section (15).

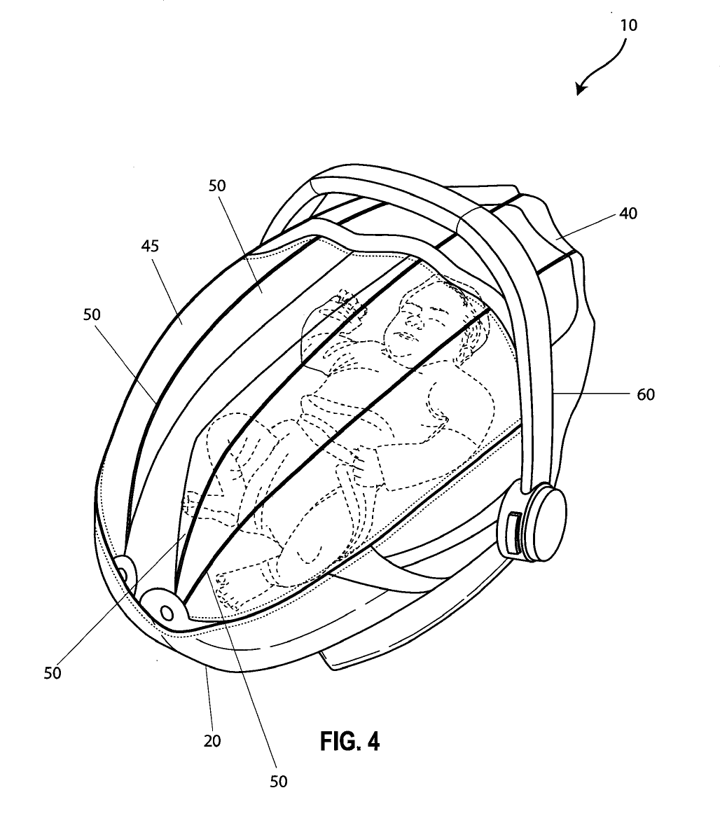

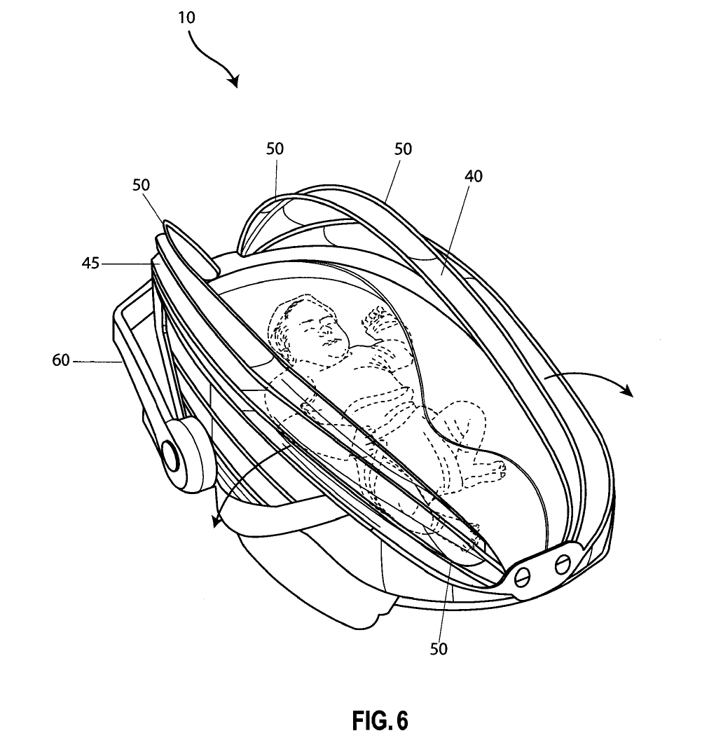

As best shown in FIGS. 4-6, canopy (15) is configured in a manner to allow for canopy (15) to open laterally. In this configuration, support rods (50) run along the vertical axis in relation to the orientation of an occupant. In other words, support rods (50) are configured, at least in this embodiment, in a manner that is perpendicular to the direction of the canopy when being opened or closed, as shown in FIG. 6 (see arrows).

As described above, support rod (50) provides a supporting element that is resilient and may also be folded to a reduced state so that when sound buffering apparatus (10) is not in use, it may be easily removed from an infant device, such as a car seat. It should be appreciated that support rods (50) and the accordion structure of canopy (15) provides for easy access to the infant contained therein. Moreover, sound buffering apparatus (10) may also be conveniently folded in a compact manner to provide ease in storage of sound buffering apparatus (10).

As shown in FIGS. 1-9 canopy (15) is generally comprised of a sheet (55) which may be made from sound deadening or sound buffering material including but not limited to, foam, plastic or fabric that is adapted to cover a substantial portion of an infant, thereby reducing both sound or the decibel level coming from the child and the decibel level or sound traveling or being received by a child. This creates a quieter environment for the child while serving a dual purpose to reduce any noise coming from the child.

In similar related embodiments, sheet (55) may be a light-weight rubber layer or olefin foam having one surface to which an unwoven fabric or a woven fabric of cotton, neoprene, polyester, or the like may be mechanically or chemically coupled. While it should be appreciated that sheet (55) may comprise a single material that provides a significant amount of sound dampening that is a result of the structural properties of sheet (55) itself. Structural properties may include microcavities that prevents a significant portion of sound from entering and/or leaving canopy (15) when in a closed position (see FIGS. 1, 4 and 7). Materials such as those are found in U.S. Pat. Nos. 5,897,164 and 7,891,732, which are incorporate herein by references in their entirety, and may be utilized.

Additionally, sheet (55) must be sufficiently pliable and light-weight to allow a user to conveniently attach canopy (15) to an infant device. While sheet itself (55) is generally stretchable, or contains a feature with elastic properties, sheet (55) is not overly stretchable as to not provide a taught structure to prevent slack or excess canopy (15) from bunching in between support rods (50).

The basic concepts of the invention described herein may be embodied in a variety of ways. It involves both methods and devices to accomplish the appropriate method. In this application, the methods are disclosed as part of the results shown to be achieved by the various devices described and as steps that are inherent to utilization. They are simply the natural result of utilizing the devices as intended and described. In addition, while some devices are disclosed, it would be understood that these not only accomplish certain methods but also can be varied in many ways. Importantly, as to the foregoing, all these facets should be understood to be encompassed by this disclosure.

As mentioned earlier, the various embodiments of the present invention include a variety of components that may be used in different combinations, depending on the application that needs to be addressed. The invention is designed primarily to take advantage of a unique protective cover apparatus and method of protecting occupants of baby seats and combine and modify it as needed for a variety of shapes, sizes, and orientations, as will be explained in more detail as the figures are described. This invention is intended to encompass a wide variety of uses in the goals and objects of the protecting cover. Elements, functions, and procedures that distinguish the invention will be noted where appropriate.

The term “infant device” as used herein is intended to include those, such as car seats, vehicle seats, baby seats, glider seats, automatic swing seats, cribs, strollers and so forth encompassing any suitable seat which may be a surface where babies and infants or even toddlers (generally referred to as infants) may be placed.

FIGS. 1-9 show a typical installation of sound buffering apparatus (10) over an infant car seat with a carrying handle. Such a canopy offers the advantage that access to an infant does not require the handle to be positioned in one particular configuration. As shown handle (60) may be held, used, or even retracted independently of the self-supporting feature of canopy (15).

Although the air flow is deemed to be adequate in the invention, one of ordinary skill in the art may desire side venting to provide sound dampening, but significant ventilation for an infant contained therein. This situation could occur, for instance, in warmer climates. The material can also be a mesh material to protect child from insects while providing ventilation.

The methods that may be claimed in this invention are well within the knowledge of one or ordinary skill in the art. For instance, suspending the canopy over a baby seat, sealing the canopy, supporting the canopy, utilizing a canopy and allowing the canopy to be retained in a rearward direction and alternative allowing the canopy to be capable of canopying in a forward direction. It could also include resisting the exiting of a substantial amount of sound from the infant, while allowing an infant to be viewed through a window. Therefore, no separate discussions of the methods are deemed necessary as they may claim steps that are implicit in the use and manufacture of the apparatus claims. Furthermore, although the steps may be organized in a logical fashion, however, other sequences can and do occur. Therefore, any method claims should not be construed to include only the order of the sequence of steps presented.

The foregoing discussion and claims that may follow describe only the preferred embodiments of the invention. While particular embodiments of the invention have been described, it will be obvious that changes and modifications may be made without departing from the broad aspects of the present invention. Particularly with respect to the claims, it should be understood that a number of changes may be made without departing from its essence. In this regard, it is intended that such changes—to the extent that they substantially achieve the same results in substantially the same way—would still fall within the scope of the invention. It is simply not practical to describe and claim all possible revisions and claims to the invention that may be accomplished. To the extent such revisions utilize the essence of the invention, each would naturally fall within the breath of protection by any patent granted. This is particularly true for the invention since most of the basic concepts are fundamental in nature and it can be properly applied.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the invention to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

What is claimed is:

1. A sound buffering apparatus comprising:
a canopy;
a sealing element;
a panel and
a closing mechanism wherein said canopy comprises a material capable of reducing sound from passing thererthrough in combination with an infant device.

2. A sound buffering apparatus of claim 1, wherein said panel further comprises a window.

3. A sound buffering apparatus of claim 1, wherein said canopy is supported by at least one rod.

4. A sound buffering apparatus of claim 1, wherein said closing mechanism is selected from a group consisting of a strap, clip, hook and loop fastener, zipper, button, snap, adhesive or any other formed shapes meant to aid and support panel.

5. A sound buffering apparatus of claim 1, wherein said infant device is selected from a group consisting of a car seat, a vehicle seat, a baby seats, a glider seat, a crib, a stroller and an automatic swing seat.

6. A sound buffering apparatus of claim 1, wherein said canopy comprises a material selected from a group consisting of plastic, cotton fabric, light-weight rubber, olefin foam, unwoven fabric, a woven fabric, neoprene and polyester.

7. A method of dampening sound comprising:
disposing a sound buffering apparatus on an infant device forming a cavity wherein said sound buffering apparatus comprises a canopy, a sealing element and a closing element;
placing an infant in said infant device; and
closing said canopy thereby preventing a substantial portion of sound from entering or exiting the internal portion of said cavity.

8. A method of claim 7, wherein the sound buffering apparatus comprises a canopy, a sealing element, a closing mechanism and a panel.

9. A method of claim 7, wherein said panel further comprises a window.

10. A method of claim 7, wherein said canopy is supported by at least one rod.

11. A method of claim 7, wherein said closing mechanism is selected from a group consisting of a strap, clip, hook and loop fastener, zipper, button, snap, adhesive or any other formed shapes meant to aid and support panel.

12. A method of claim 7, wherein said infant device is selected from a group consisting of a car seat, a vehicle seat, a baby seats, a glider seat, a crib, a stroller and an automatic swing seat.

13. A method of claim 7, wherein said canopy comprises a material selected from a group consisting of plastic, cotton fabric, light-weight rubber, olefin foam, unwoven fabric, a woven fabric, neoprene and polyester.

14. A method of claim 7, wherein said canopy being opened or closed in a generally horizontal manner.

15. A method of claim 7, wherein said canopy being opened or closed in a generally vertical manner.
